(19) United States
(12) Patent Application Publication
(10) Pub. No.: US 2012/0006168 A1
(43) Pub. Date: Jan. 12, 2012

(54) ALL IN ONE WINDOW COVERING CUTDOWN MACHINE

(76) Inventors: Cletis Frazier Swopes, Janesville, WI (US); Steven John Neumaier, Sauk City, WI (US)

(21) Appl. No.: 12/986,757

(22) Filed: Jan. 7, 2011

Related U.S. Application Data
(63) Continuation of application No. PCT/US2009/050248, filed on Jul. 10, 2009.
(60) Provisional application No. 61/079,738, filed on Jul. 10, 2008.

(51) Int. Cl. B26D 7/02; B26D 7/28; B23D 23/00

(52) U.S. Cl. 83/453; 83/648; 83/522.19

(57) ABSTRACT

A cutdown machine for window coverings includes a central work surface and cutting stations at each end, above and behind and below and in front of the work surface. The machine fits in a standard display bay of a home improvement store, and includes a cutting station that extends in front thereof to cut a vertical blind headrail that is longer than the width of the bay.

### CROSS REFERENCE TO RELATED APPLICATIONS

This is a continuation of PCT application No. PCT/US2009/050248, entitled “ALL IN ONE WINDOW COVERING CUTDOWN MACHINE”, filed Jul. 10, 2009, which claimed priority from U.S. provisional patent application Ser. No. 61/079,738, entitled “ALL IN ONE WINDOW COVERING CUTDOWN MACHINE”, filed Jul. 10, 2008, which are incorporated herein by reference.

### FIELD OF THE INVENTION

The present invention relates to cutting apparatus and methods for trimming window coverings such as window blinds that are trimmed at the time of purchase at retail stores.

### BACKGROUND OF THE INVENTION

Different approaches have evolved to prepare window blinds and other window coverings to be of the dimensions needed to cover a particular window (or other architectural opening) for a specific customer. In one approach, an installer or decorator measures the opening to determine the appropriate dimensions, and a window covering is ordered from the manufacturer or fabricator, where the blind is built to the required dimensions. The completed blind is shipped and installed. While custom manufacturing normally provides a blind of the appropriate size, a disadvantage of this procedure is the time required, whereby several days or even weeks may elapse from initial measuring to final installation. Custom manufacturing also can be expensive.

Another approach involves manufacturing and supplying retail stores with blinds in a number of “stock” sizes for each blind variety. The customer then selects a size that most closely approximates the size of the window to be covered. However, if only a small number of stock sizes are provided, the likelihood of a customer finding a stock size that fits appropriately is reduced. Providing more stock sizes can mitigate fitting difficulties; however, to do so necessarily requires retailers to take on greater inventory and provide more shelf space for the blinds being stocked.

A solution to the foregoing problems has led to a now popular approach, a so-called “size-in-store” system, in which a relatively small number of stock sizes of each blind are provided to the retail outlet. The blinds are designed in a manner such that the headrails, slats (or other window covering materials) and bottom rails can be trimmed at either and preferably at both ends. “Size-in-store” programs from manufacturers typically include providing the retail store outlet with a cutdown machine designed to cut the particular blinds or other window coverings. When a store handles different types of window coverings, it has been necessary to have different cutdown machines for the different products, requiring dedicating space to numerous cutdown machines that could be used otherwise for the display of products.

While many different types of cutdown machines exist, certain characteristics are common to many of the machines. Typically, the machines include means for cutting the headrail, the slats (or other window covering material) and the bottom rail of the window covering. In certain situations, different approaches and tools are used to cut the headrail, the slats and/or the bottom rail. In other designs, two or more components are cut by one of the cutting implements. Additionally, known cutdown machines allow for cutting both sides of the window covering, to provide a trimmed window covering having an attractive finished look with the amount that is cut from each component being approximately the same. However, the machines and methods are not always adequate in providing systems for sizing window shades efficiently and accurately. For example, some of the systems are too complex to be operated by a typical retail salesperson having only an average amount of training and experience.

A cutdown program may include multiple product lines requiring several different machines with which to cut them. End stop adjustments and cutting instructions vary from one cutdown machine to another. Untrained, inexperienced or new store associates often have difficulty with correctly setting and operating the machines. When mistakes are made in trimming blinds, it is often necessary to discard a blind and start over, thus impacting the profitability of the program.

Another problem that has been encountered in cutdown programs for vertical blinds is that a vertical blind may have a headrail that is longer than the width of a standard bay opening in the store. Cutdown machines for such blinds have had to be located in areas that are not restricted by the framework of display bays. This can be some distance from the location for displaying and selling other window covering materials.

Therefore, there is a need for a cutting apparatus for window treatments capable of customizing window treatments efficiently, to fit window dimensions specified by customers. Also, there is a need for a cutting apparatus for cutting a window covering to a specified width, whereby the entire window covering, namely the headrail, the bottom rail and the window covering material are all cut in one setting of the machine, thereby saving time and reducing operator errors. Moreover, the cutting apparatus should produce a final product having a high quality and a professionally cut appearance. Further, there is a need to provide a cutdown machine that can be used to cut window coverings of different styles and types. Still further, there is a need for a window covering cutdown machine that is simple to operate and capable of cutting many different types of window coverings on a single machine requiring minimal space. Yet further, there is a need for a window covering cutdown machine that can be installed in a standard display bay opening, yet can be adjusted to cut head rails and other window covering materials of lengths longer than the width of the bay opening.

### SUMMARY OF THE INVENTION

The present invention provides a window covering cutdown machine that can be used for cutting window coverings of various types and of various materials, including but not limited to wood and other natural materials, faux wood, solar shades, vinyl shades, vinyl blinds, cellular blinds, and both vertical and horizontal coverings. The machine incorporates multiple discrete cutting centers or stations in a compact arrangement that is convenient to use. The machine can be used for cutting window coverings having a length longer than the width of a standard bay in warehouse style home improvement stores having fixed display racks.

The invention in one form is directed to a cut down machine for cutting window blind products of different types, with a window blind support surface; first and second window blind cutting stations on opposite ends of the support surface; and a third window blind cutting station extendable outwardly from the front of the cutdown machine.

The invention in another form is directed to a cut down machine for cutting window blind products of different types, with a window blind support surface. The machine has a miniblind cutting station at one end of the window blind support surface positioned for receiving ends of miniblinds supported by the window blind support surface, a wood and faux wood cutting station having a saw at an opposite end of the window blind support surface from the miniblind cutting station, the wood and faux wood cutting station being positioned for receiving ends of wood and faux wood blinds supported on the window blind support surface; and a vertical blind headrail cutting station including a headrail clamp movable toward and away from the support surface and having a retracted position beneath the window blind support surface, and a headrail die movable toward and away from the miniblind cutting station.

The invention in still another form is directed to a cut down machine for cutting window blind products of different types, including vertical blind headrails and louvers. The cutdown machine has a window blind support surface, a plurality of cutting stations for receiving ends of window blinds supported by the window blind support surface; and a vertical blind headrail cutting station including a headrail clamp movable between a stowed position beneath the window blind support surface and a use position outwardly from an edge of the window blind support surface, and a headrail die near an end of the window blind support surface.

An advantageous feature of at least one form of the present invention is that a single machine is provided for cutting common window covering types sold in cutdown programs, and fewer machines are needed requiring less space.

Another advantageous feature of at least one form of the invention is that while a single machine is provided, the various cutting stations are independent of one another at various locations around work surface 102. Accordingly, if one station is out of service for repair or maintenance, other work stations are not necessarily affected and can be used.

Still another advantageous feature of at least one form of the invention is that headrails longer than the width of a standard bay can be cut on a machine installed in a bay.

### BRIEF DESCRIPTION OF THE DRAWINGS

The above-mentioned and other features and advantages of this invention, and the manner of attaining them, will become more apparent and the invention will be better understood by reference to the following description of an embodiments of the invention taken in conjunction with the accompanying drawings, wherein:

FIG. 1 is a perspective view from the front of a cutdown machine;

FIG. 2 is a perspective view of the back of a cutdown machine, with some of the protective covers removed;

FIG. 3 is an elevational view of the right side of the cutdown machine as shown in FIG. 1 or the left side as shown in FIG. 2;

FIG. 4 is a fragmentary perspective view of the inner side of the miniblind cutdown station in the cutdown machine, showing a miniblind inserted for cutting;

FIG. 5 is a fragmentary view of the end of the miniblind cutdown station with a miniblind inserted therein for cutting;

FIG. 6 is a fragmentary perspective view of the inlet throat of an upper cutdown station in the cutdown machine for cutting cellular blinds and vertical blind louver stacks;

FIG. 7 is a fragmentary perspective view of the cutdown station shown in FIG. 6, illustrating a cellular blind therein for cutting;

FIG. 8 is a fragmentary perspective view of the cutdown machine in an adjusted position for cutting the headrail of a vertical blind;

FIG. 9 is a fragmentary perspective view of the front of the cutdown machine in the adjusted position as shown in FIG. 8;

FIG. 10 is an enlarged fragmentary view of a scale in the vertical headrail cutting station of the cutdown machine;

FIG. 11 is a fragmentary perspective view of the cutdown machine and particularly the vertical blind headrail cutting station thereof, depicting a vertical headrail positioned for cutting;

FIG. 12 is an enlarged fragmentary view showing the headrail clamp for the vertical blind headrail cutting station, with the clamp in a fully opened position;

FIG. 13 is an enlarged fragmentary view of the vertical blind headrail clamp in a partially closed condition;

FIG. 14 is an enlarged fragmentary view of the vertical blind headrail clamp in a fully closed, clamping position;

FIG. 15 is a fragmentary perspective view from the front of the cutdown machine illustrating a vertical headrail positioned for cutting;

FIG. 16 is an enlarged fragmentary view of the end of the cutdown machine, illustrating a vertical headrail as positioned in the previous drawing, shown in readiness for cutting;

FIG. 17 is a further enlarged view of the end of a vertical headrail positioned for cutting;

FIG. 18 is a fragmentary perspective view of a stack of louvers from a vertical blind positioned for cutting in the upper cutting station;

FIG. 19 is an enlarged fragmentary perspective view of the left side of the cutdown machine as shown in FIG. 1;

FIG. 20 is an enlarged fragmentary view of an inner portion of the same end of the cutdown machine;

FIG. 21 is a fragmentary perspective view showing a blind ready for insertion into the cutting station shown in the immediately preceding drawings;

FIG. 22 is a fragmentary perspective view of the blind shown in the previous drawing fully positioned for cutting

FIG. 23 is a fragmentary end view of the miniblind cutting station, with the cutting dies thereof positioned in a first relative position; and

FIG. 24 is a fragmentary end view of the miniblind cutting station, with the cutting dies thereof positioned in a second relative position.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

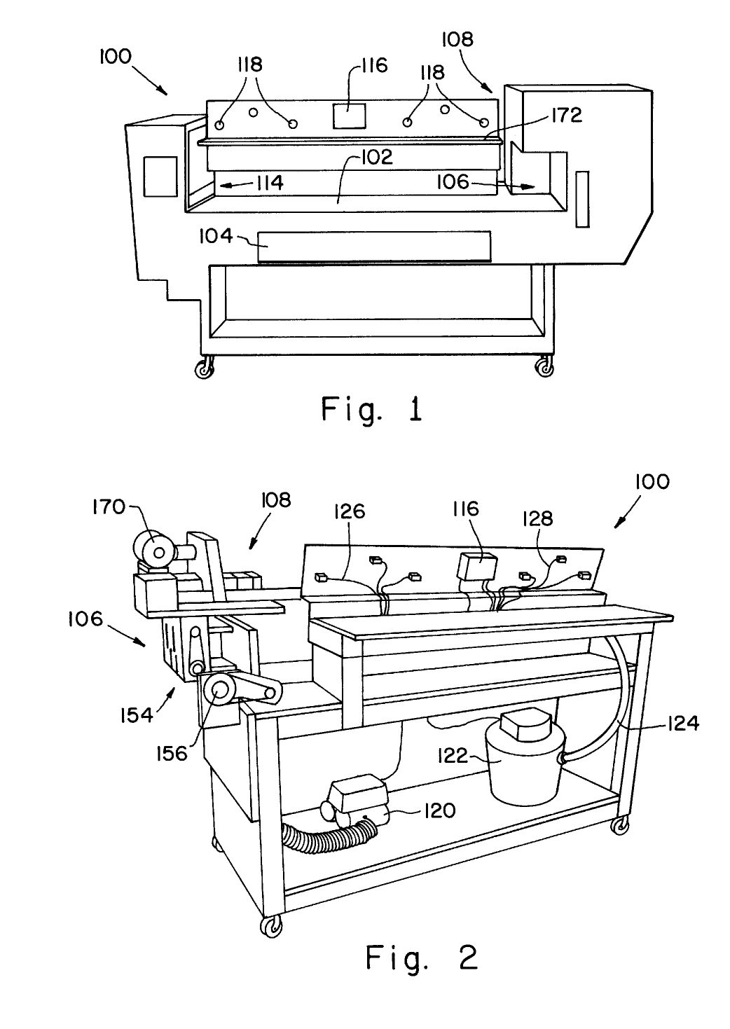

Referring now to the drawings, and more particularly to FIG. 1, there is shown a cutdown machine 100 which generally includes cutting stations on opposite ends of a combination work surface/support surface 102. The flat, table-like area of work surface 102 is particularly convenient for arranging and preparing window coverings prior to cutting. At the front of work surface 102, a pullout drawer 104 is provided for a vertical blind headrail cutdown station, as will be described subsequently. An advantage of the present invention is that the cutdown machine will fit completely within a standard size single bay in so-called “big box” stores and home improvement stores. When cutting vertical blind headrails, which can have a headrail length (i.e. the width of the blind) that is longer than the width of a standard bay opening. Drawer 104 pulls out only a small distance (approximately six inches) for supporting the vertical blind headrail in front of the bay, thereby allowing the vertical headrail to extend in front of the adjacent bay next to the cutdown machine. When drawer 104 is in the closed or stowed position, cutdown machine 100 does not protrude outwardly in front of the bay. Even with drawer 104 open, intrusion into the aisle is minimal.

Cutdown machine 100 is a compact, multiproduct cutting center providing convenient access for cutting all common window coverings products sold through in-store cutdown programs. Work surface 102 provides a large, central, table-like surface on which various products can be prepared for cutting at different locations toward one end or the other of cutdown machine 100. Four separate product cutting stations are provided in locations at each end of work surface 102, generally above and behind work surface 102 and generally below and in front of work surface 102.

A miniblind cutting station 106 is provided at one end of work surface 102. An upper cutting station 108 is provided generally above and behind work surface 102 and miniblind cutting station 106. Upper cutting station 108 is suitable for cutting cellular blinds and louvers for vertical blinds. Drawer 104 and an extendable die cutter assembly 110 adjacent miniblind cutting station 106 provide a vertical blind headrail cutter 112. A wood/faux wood cutting station 114 is provided at the end of work surface 102 opposite from miniblind cutting station 106. Wood/faux wood cutting station 114 utilizes both die cutting and a band saw, as will be shown and described subsequently herein. An operator input panel in the nature of a touch screen controller 116 is provided above work surface 102. Activation buttons 118 are provided near each end of machine 100. Alternatively, operation of cutdown machine 100 can be an automatic sequence commenced via touch screen controller 116.

It will be readily understood by those skilled in the art that the general arrangements and configurations of cutting stations shown and described herein are merely exemplary in nature. The cutting stations shown at one end of work surface 102 can be provided at the opposite end of work surface 102, essentially reversed right for left from that shown and described. Further, while miniblind cutting station 106, upper cutting station 108 and extendable die cutter 110 are grouped together at one end of work surface 102, it should be understood that other arrangements are possible, grouping one or more of upper cutting station 108 and/or extendable die cutter 110 at the opposite end with wood/faux wood cutting station 114.

FIG. 2 shows the back of machine 100, from which can be seen a compressor 120 for operating the various die cutting apparatus, and a vacuum 122 with a vacuum hose 124, vacuum 122 being provided for accumulating saw dust and debris from the wood/faux wood cutting station, which utilizes a band saw. Wiring harnesses 126, 128 connect compressor 120 and vacuum 122 to touch screen controller 116 and activation buttons 118. When hooked to a source of electrical power, cutdown machine 100 is self-contained and includes cutting stations suitable for cutting most common types of window coverings supplied through cutdown programs in home improvement centers or the like.

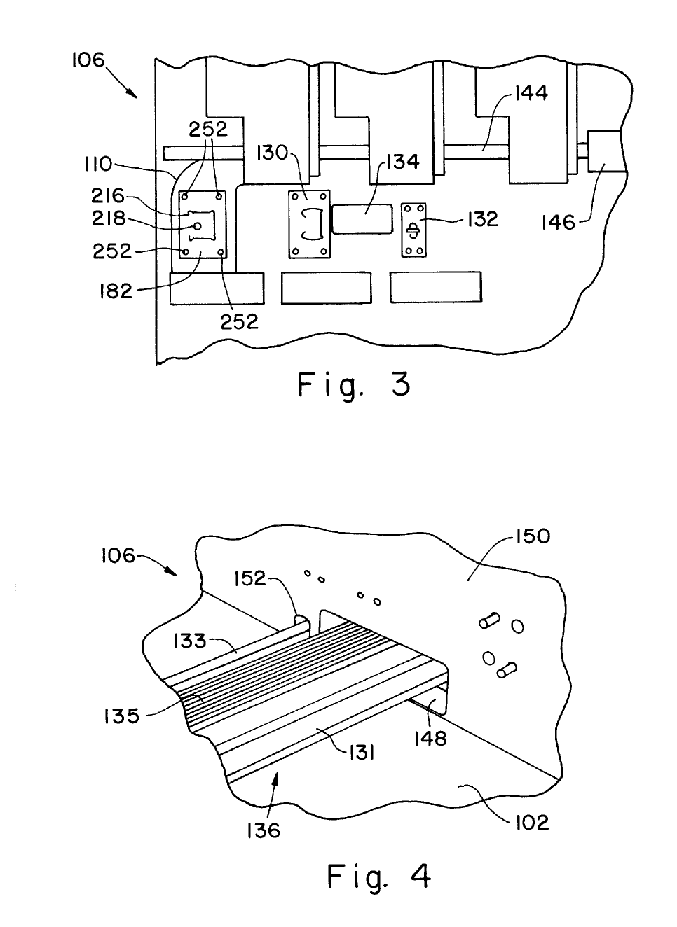

With reference now particularly to FIGS. 3-5, miniblind cutting station 106 will be described more fully. Miniblind cutting station 106 includes die cutting apparatus for the headrail and bottom rail, and knife blade cutting apparatus for the slats of a miniblind as are known in individual miniblind cutting machines. For example, cutting means substantially as shown and described in U.S. Pat. No. 6,178,857 can be used, either manually operated or preferably, pneumatically operated and powered from compressor 120.

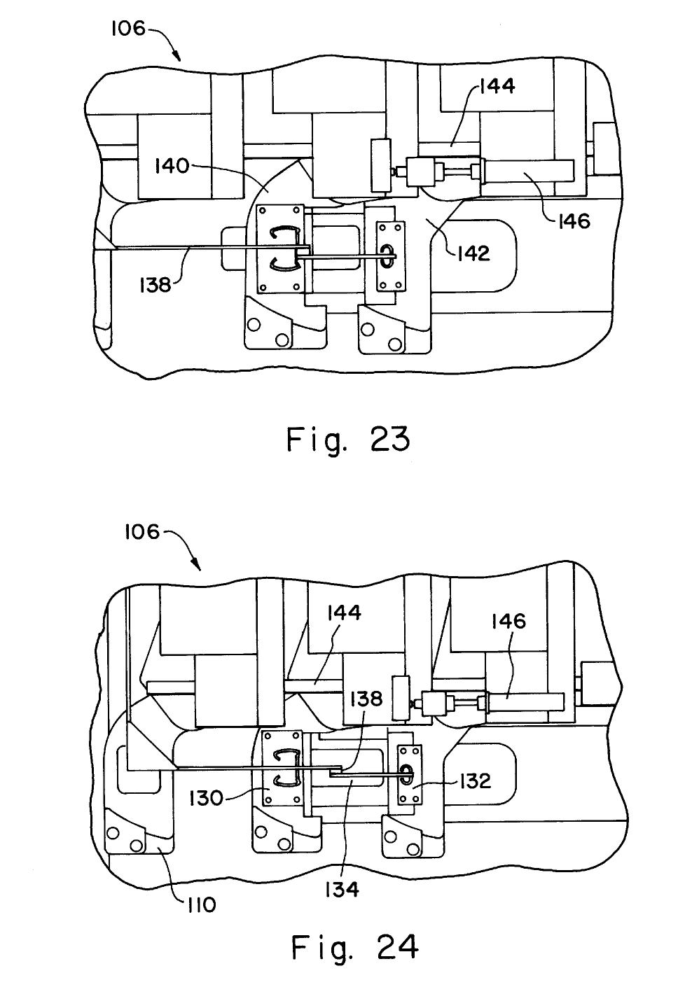

In the exemplary embodiment for miniblind cutting station 106 shown in the drawings, a headrail cutting die 130 and a bottom rail cutting die 132 are provided on opposite ends of a slat opening 134 for receiving and cutting a headrail 131, a bottom rail 133 and a group of slats 135, respectively, of a miniblind 136. Die cuts of the headrail and bottom rail are performed in known fashion, and the slats are cut by a knife-like blade as known in the art. An automatic end stop system 138 (FIGS. 23 and 24) is provided outwardly of headrail die 130, bottom rail die 132 and slat opening 134 to engage the ends of miniblind 136 and establish the portion to be cut therefrom. End stop system 138 is automatically adjusted from data input relative to the dimensions of the miniblind to be cut and the desired final dimensions for the miniblind after cuts have been made.

Headrail die 130 and bottom rail die 132 are separately and independently mounted and can be adjusted relative to one another to vary the space therebetween. Accordingly, die holders 140, 142 for headrail die 130 and bottom rail die 132 are slidably mounted on a rail 144 and can be laterally adjusted via an actuator or actuators 146. The capability of providing variable spacing accommodates cutting different sizes and/or types of miniblinds having more slats or more slat volume per slat to be cut in slat opening 134. In the closed and packaged form from which a miniblind is commonly cut, a smaller blind having fewer slats or thinner slats defines a smaller space between the headrail and bottom rail thereof than does a blind of another size or type having more slats or thicker slats. Thus, to position different blinds suitably between headrail cutting die 130 and bottom rail cutting die 132 may require different spacing between headrail die 130 and bottom rail die 132. FIGS. 23 and 24 show adjusted positions for headrail die 130 and bottom rail die 132, with the spacing between the dies being narrower in FIG. 23 and wider in FIG. 24. The adjustment can occur automatically, through software, when the controller becomes aware of the type of blind being cut, either from input by the operator or from scanning bar code information on the blind during the starting sequence for cutting the blind.

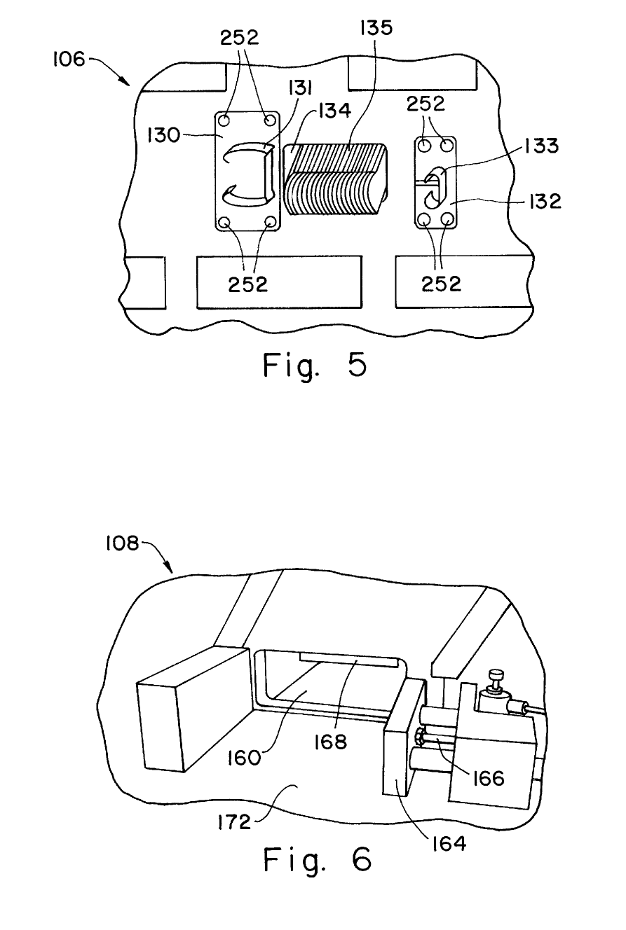

As shown in FIG. 4, on the inside of miniblind cutting station 106, a large opening 148 is provided in a plate 150 adjacent work surface 102, opening 148 being provided as access for slat opening 134 and headrail die 130. A smaller opening 152 is provided through plate 150, as access to the bottom rail die 132. Viewed from opposite sides of miniblind cutting station 106, FIGS. 4 and 5 show the alignment and positioning of miniblind 136, which is inserted into the cutting station and ready for cutting. FIG. 4 illustrates headrail 131 and slats 135 inserted through large opening 148 and bottom rail 133 inserted through smaller opening 152. FIG. 5 shows headrail 131 of miniblind 136 inserted through headrail die 130, bottom rail 133 inserted through bottom rail die 132 and slats 135 inserted through slat opening 134. Operation of the dies for cutting the headrail and bottom rail, and of the knife for cutting the slats occur together by way of the electric and pneumatic systems of cutdown machine 100, including a system of pneumatic actuators 154 and/or mechanical drives 156, which may include gear drives, belt drives, chain drives lead screws and other suitable drive mechanisms.

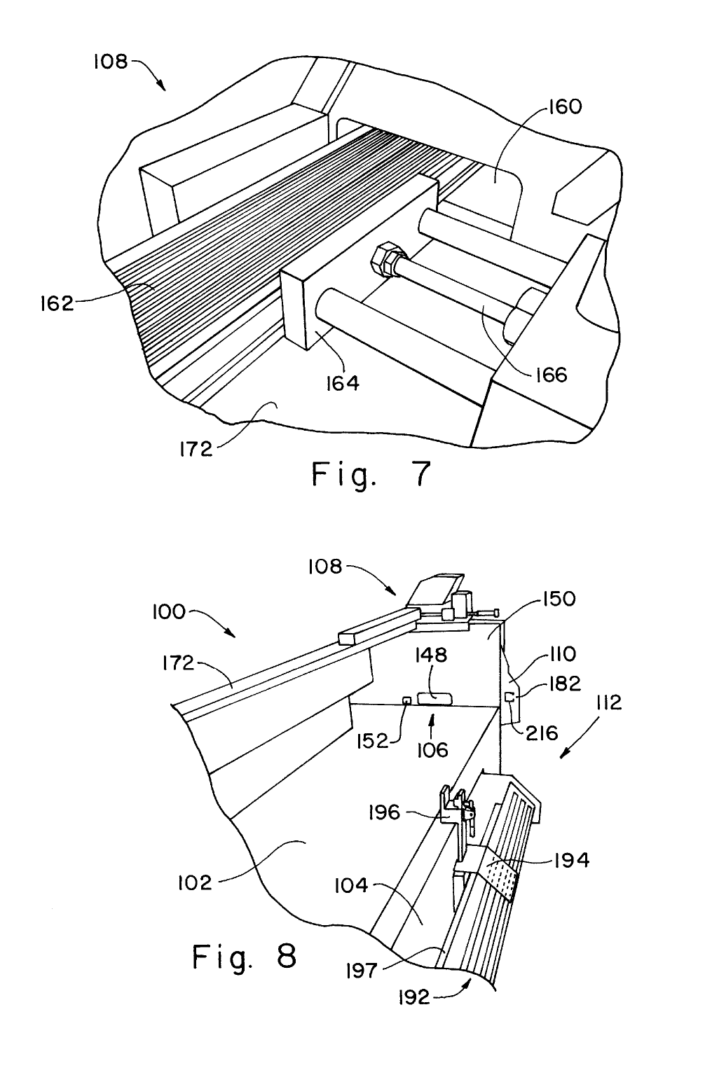

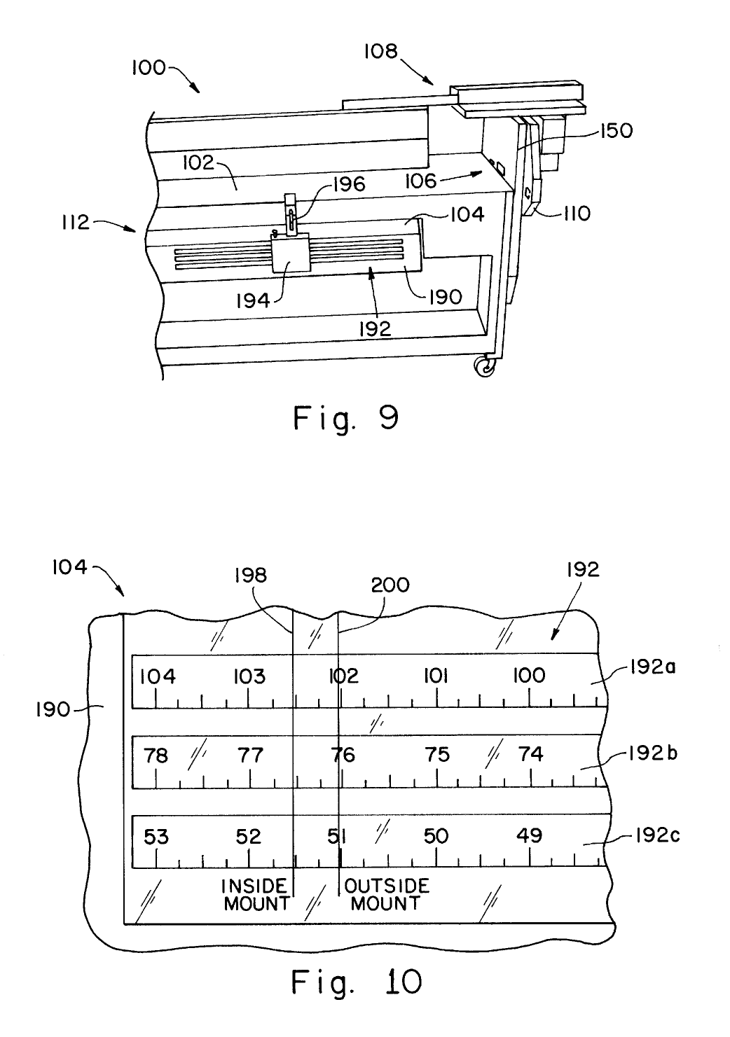

Cellular blinds are cut at upper cutting station 108, which is provided at the upper edge of machine 100, generally above and behind work surface 102 and miniblind cutting station 106. Upper cutting station 108 includes a throat 160 (FIGS. 6, 7) through which a cellular blind 162 is inserted. The blind is held by a vice or clamp 164 operated by a pneumatic actuator 166, and cutting is performed by a knife 168 as known to those skilled in the art. For example, a cutting mechanism substantially as shown and described in U.S. Pat. No. 6,681,673 can be used. However, instead of manual operation of the cutting knife therein, further mechanical or pneumatic actuators 170 can be used powered electric motors or from compressor 120. A ledge 162 (FIGS. 1, 18) is provided for supporting the blind. FIG. 6 shows the empty upper cutting station 108, and FIG. 7 shows a cellular blind 162 clamped in position for cutting.

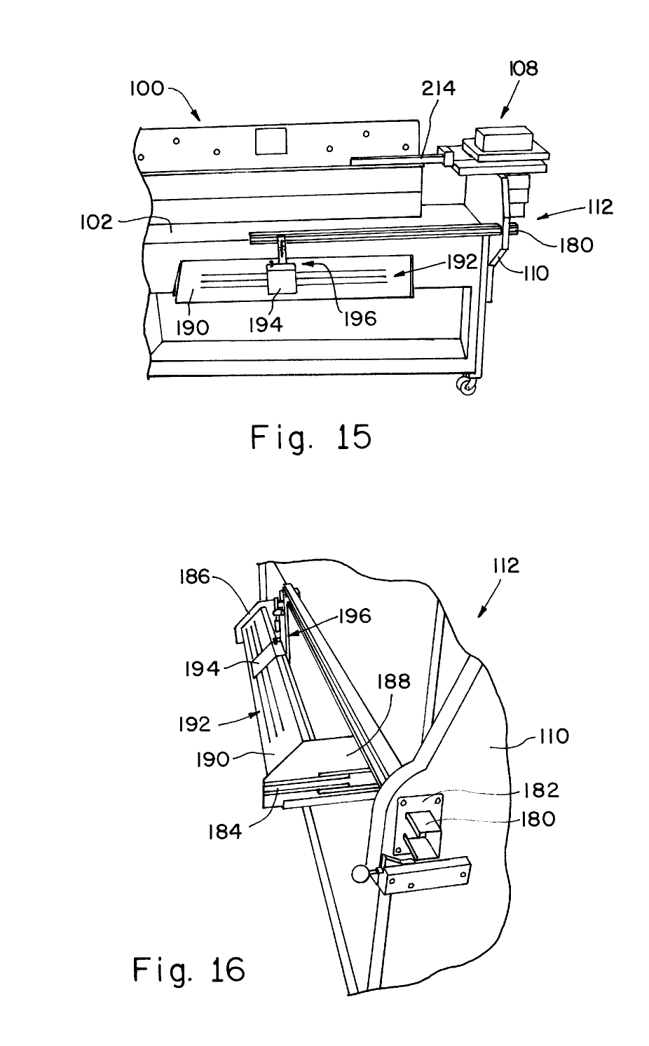

Vertical blind components are cut in two locations. As mentioned previously, drawer 104 at the front of cutdown machine 100 is pulled outwardly to measure and support a vertical blind headrail assembly 180, which is cut in a vertical blind headrail die 182 that is moved from its stored position as shown in FIG. 3 to an outward position in readiness for cutting, as shown for example in FIGS. 15-17. Vertical louvers of a vertical blind are cut in upper cutting station 108.

Drawer 104 is suspended and moveable on telescoping drawer slides 184 of sufficient rigidity and strength to hold drawer 104 in an outwardly extended position without unacceptable deflection or bending while supporting a vertical blind headrail. Drawer 104 includes sides 186, 188 and an angular front panel 190. A ruler 192 having increments thereon for inside and outside mounting calibrations for headrail measurement is provided on angular front panel 190. Ruler 192 can be provided as an adhesive overlay on angular front panel 190; as an insertable card held on angular front panel 190; as a graphic image printed, transferred, painted or otherwise applied onto the surface of angular front panel 190 or in any other suitable stable form on angular front panel 190.

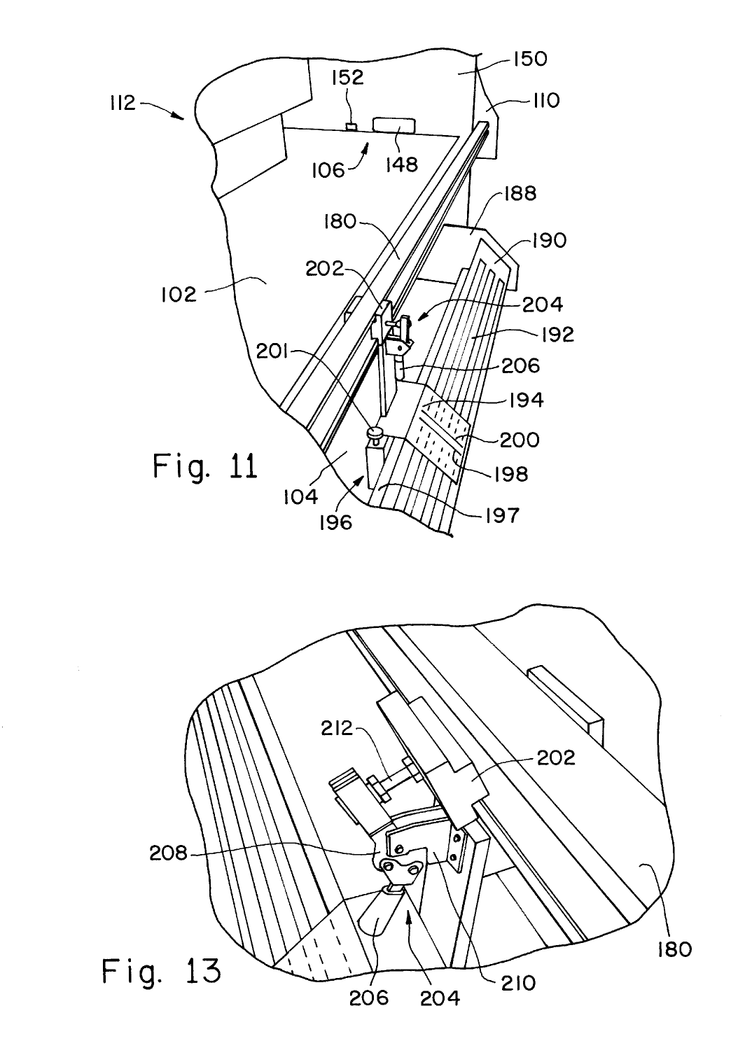

A hairline sight 194 is attached to a sliding clamp 196 which holds headrail assembly 180. By sliding clamp 196 along a track 197 (FIG. 8) on drawer 104 and aligning hairline sight 194 at the proper location on ruler 192, a vertical blind headrail held in clamp 196 is positioned to have the proper amount cut therefrom. FIG. 10 is a close-up illustration of an exemplary ruler 192. As can be seen in FIG. 10, hairline sight 194 is provided with individual hairlines 198, 200 for setting clamp 196 at the appropriate positions when cutting a headrail to be installed in an inside mount or outside mount, respectively. Clamp 198 is secured in the set position relative to movement along track 197 by tightening a set screw 201 (FIG. 11). Ruler 192 can include a plurality of scales thereon (scales 192a, 192b and 192c being shown in FIG. 10) and can include a half-scale ruler as known to those familiar with window covering cutdown procedures so that clamp 196 can be set with either hairline 198 or hairline 200 on the appropriate desired final dimension on the scale, and headrail assembly 180 centered in clamp 196 first to cut a portion from one end of headrail assembly 180 and then rotated to cut a similar portion from the opposite end of headrail assembly 180. Alternatively, ruler 192 can be a full scale ruler designating one-half of the desired final dimensions for headrail assembly 180.

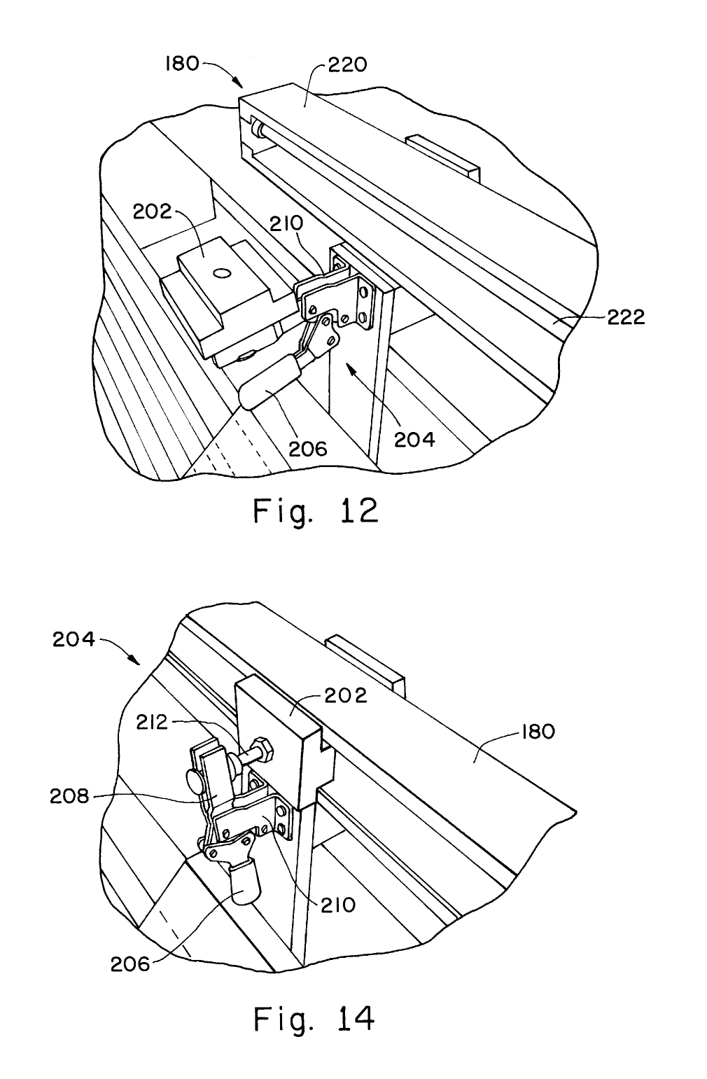

FIGS. 12-14 show operation of lever-action sliding clamp 196 which includes a formed pad 202 for engaging the open face of headrail assembly 180, and a lever-acting lock mechanism 204 for moving pad 202 into and out of engagement with the headrail, and for locking the pad in position. Accordingly, a handle 206 is pivotally connected to a bellcrank type arm 208 that is also pivotally connected to a fixed bracket 210. Arm 208 is further connected via a rod 212 to pad 202. Accordingly, moving handle 206 moves bellcrank arm 208 for moving pad 202 into and out of engagement with headrail assembly 180.

FIG. 15 is a fragmentary view of cutdown machine 100, with headrail assembly 180 shown positioned through extendable die cutter assembly 110 and supported on sliding clamp 196. A pack of vertical blind louvers 214 is shown positioned in upper cutting station 108. A headrail assembly 180 is cut and via super imposed die cutting plates as known to those skilled in the art. Louvers 214 are shortened by cutting with a knife 168 in the same mechanism and in the same manner shown and described previously for cutting cellular blinds.

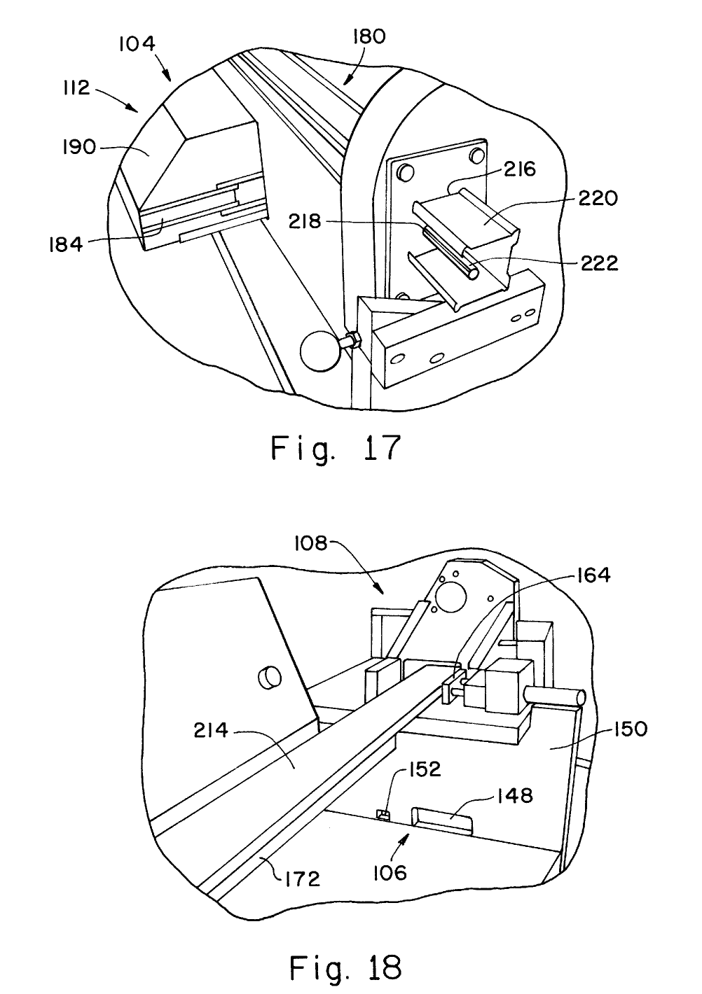

In the enlarged views of FIGS. 16 and 17, it can be seen that vertical blind headrail die 182 includes cutting apertures 216, 218 in the shape and size necessary for receiving a headrail channel piece 220 and a headrail shaft 222, respectively. Again, such die cutting mechanisms are well-known to those skilled in the art, and the operation thereof will not be described further herein.

When vertical blind headrail cutter 112 is not in use, drawer 104 and extendable die cutter assembly 110 are pushed inwardly to stored positions and therefore and do not protrude outwardly from cutdown machine 100. When a vertical headrail is to be cut, drawer 104 and extendable die cutter assembly 110 are pulled outwardly to receive headrail assembly 180. Even in the outward extended positions thereof, drawer 104 and extendable die cutter assembly 110 do not protrude significantly in front of cutdown machine 100. When the headrail cut has been completed, and after the headrail has been removed, drawer 104 and extendable die cutter assembly 110 are pushed back to the stored positions therefor.

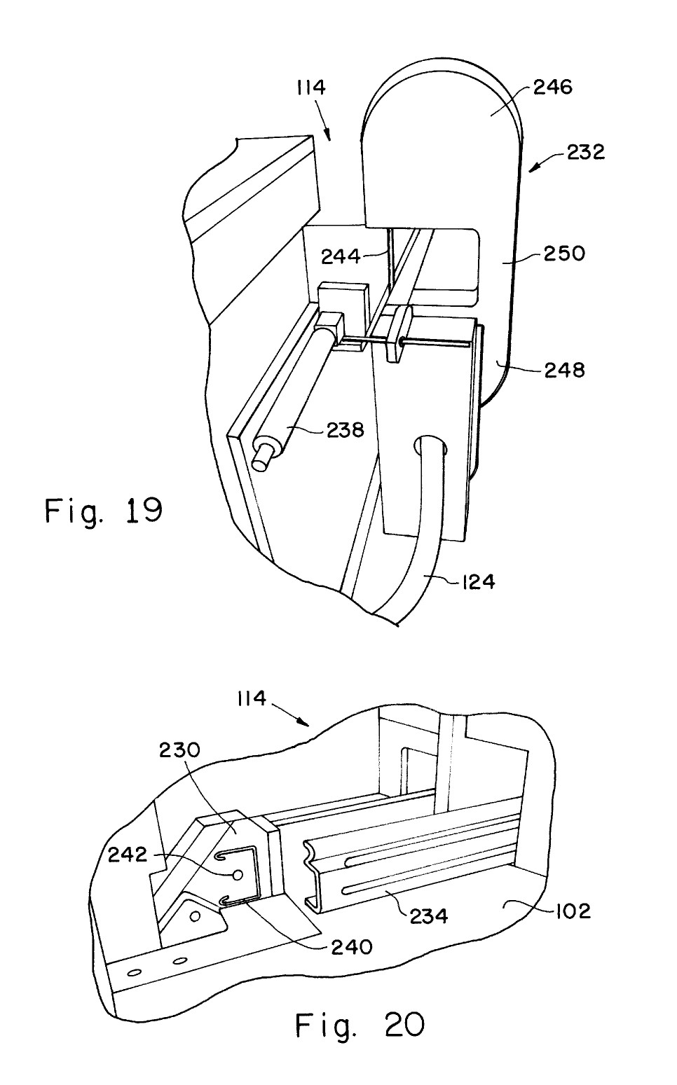

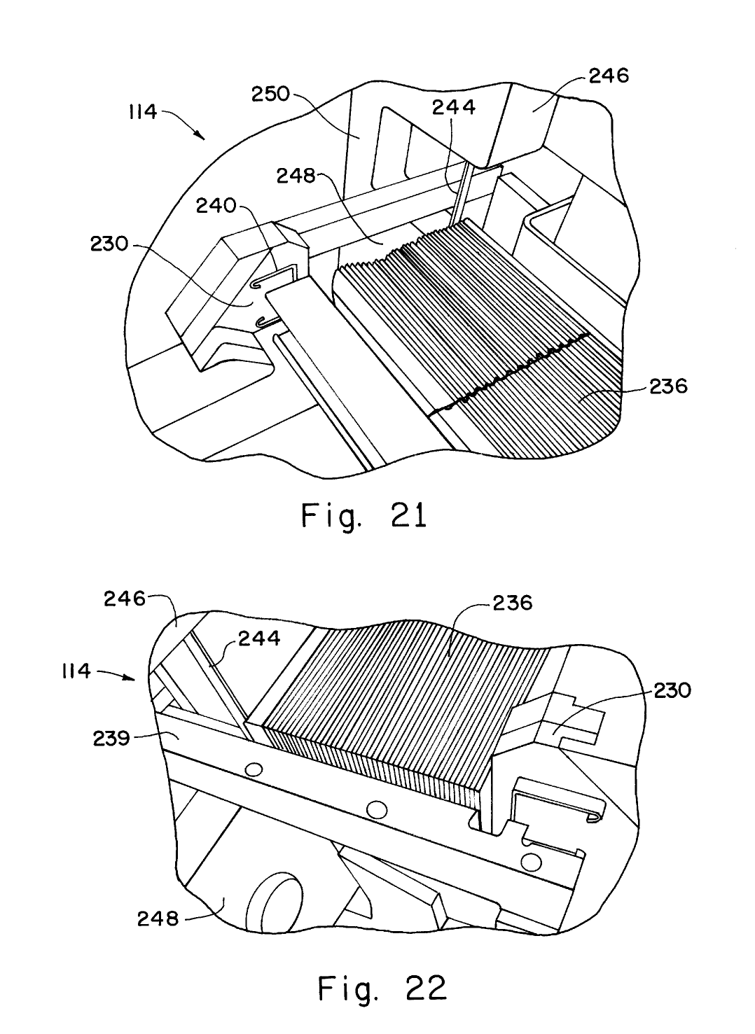

Wood and faux wood cutting station 114 is shown in FIGS. 19-22 and includes a headrail cutting die 230 and a band saw 232. A spring actuated sliding guard 234 is provided on the inside of cutting station 114, generally adjacent work surface 102. When a wood or faux wood blind 236 is to be cut, the spring actuated guard is pushed rearward, allowing the blind to be inserted. Cutting die 230 and the advancement of band saw 232 are operated simultaneously by rotation of a lead screw 238. Blind 236 is arranged on work surface 102, slid into position and clamped in place. Lead screw 238 is operated to advance band saw 232 along the end of blind 236, with blade 244 of band saw 232 cutting through the bottom rail and slats of blind 236. Rotation of lead screw 238 also operates headrail cutting die 230 by cam action, to cut the headrail of blind 236. An end stop 239 is provided and adjusted automatically by pneumatic operators or the like for positioning the end of the blind being cut for removal of an appropriate portion of the headrail, bottom rail and slats.

Headrail cutting die 230 can be of construction and operation similar to the various headrail cutting dies described previously herein. Headrail cutting die 230 defines a headrail channel piece aperture 240 and a headrail shaft aperture 242. While a single headrail channel aperture 240 and headrail shaft aperture 242 are shown in the drawings, it should be understood that multiple die apertures can be provided for cutting head rails of different configurations.

Band saw 232 can be a standard, commercially available band saw unit and includes a continuous band blade 244 of suitable size and saw tooth configuration and count for cutting the materials to be cut thereon. It is expected that universal, multi-material blade types may be used, to provide versatility in the types of materials that can be cut on cutdown machine wood/faux wood cutting station 114, which may include metals including steel and aluminum, wood and faux wood materials, and synthetic materials such as various plastics. As those skilled in the art will understand, band saw 232 can also have a multi-speed operation through use of a multi-speed motor, or a belt drive system having selectable pulley variations for changing the speed of blade 244. Continuously variable and multiple fixed speed drives are known, and may provide advantages in using cutdown machine 100 on different types of coverings for architectural openings. Band saw 232 further includes an upper compartment 246, a lower compartment 248 and a vertical support 250 extending between upper compartment 246 and lower compartment 248. As those skilled in the art will readily understand, blade 244 rotates along a path between upper compartment 246 and lower compartment 248, which includes a segment through vertical support 250. The various drive, speed control and guide mechanisms discussed above, including a suitable motor, are contained in upper compartment 246, lower compartment 248 and vertical support 250, in known manner.

When using machine 100, an operator enters cutting information via touch screen controller 116. The information entered may include the stock length and type of the blind to be cut, the desired final dimension, and whether the installation is for an inside mount or an outside mount. The stock information about the blind also can be entered by way of a bar screen scanner connected to controller 116. An appropriate scanner can be mounted on the present machine for scanning, or a handheld scanner can be used. The various necessary apparatus for cutting the type of blind designated through such entry information are enabled while other components of cutdown machine 100 not required for cutting the particular window covering to be cut will remain disabled. The end stops are positioned automatically in response to the data input. The blind is then inserted through the appropriate openings or dies until it engages the end stop. Thereafter, the machine is actuated by depressing activation buttons 118 near either end of the machine, or by enabling automatic sequencing entered at touch screen controller 116. Cutting by the band saw or by the various dies is automatic and requires no further operation. After one side of the blind has been cut, the cut end is removed from the particular cutting station which was used, the blind is rotated 180° and the yet uncut side is inserted into the appropriate cutting station. Thereafter, the machine is actuated a second time and automatically cuts the necessary amount for the final dimension desired.

Machine 100 has an open design for easy use by store personnel. Access is open and unencumbered, with work surface 102 being easily accessed without obstruction in front thereof. Accordingly, it is convenient to unpackage a window covering, prepare the window covering for cutting, and slide the window covering into the appropriate cutting station to the left of work surface 102, to the right of work surface 102, above work surface 102 at upper cutting station 108 or below and in front of work surface 102 in vertical blind headrail cutter 112.

An advantageous feature of one form of the present invention is that while a combined apparatus is provided for cutting all types of blinds, the various cutting stations are independent of one another at various locations around work surface 102. Accordingly, if one station is out of service for repair or maintenance, other work stations are not necessarily affected and can be used. The wood and faux wood cutting station, the miniblind cutting station, the vertical blind headrail cutting station and the upper cutting station are separately operated.

Another advantageous feature of another form of the invention is that the various dies, including dies 130, 132, 182 and 230, as shown in the drawings, are held in place by screws or bolts 252. Accordingly, each is easily replaceable, and dies for different headrail or bottom rail profiles can be changed quickly and easily. Repair in the event of damage also is facilitated.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

Various features of the invention are set forth in the following claims.

What is claimed is:

1. A cut down machine for cutting window blind products of different types, said cutdown machine comprising:
a window blind support surface;
first and second window blind cutting stations on opposite ends of said support surface; and
a third window blind cutting station extendable outwardly from the front of said cutdown machine.

2. The cut down machine of claim 1, said third window blind cutting station having a headrail clamp slidable outwardly from beneath said window blind support surface and a die cutter near an end of said window blind support surface.

3. The cutdown machine of claim 1, said third window blind cutting station including a drawer beneath said window blind support surface, said drawer including an angular panel having a ruler thereon for measuring the length of a window covering product cut in said third window blind cutting station.

4. The cutdown machine of claim 3, said third window blind cutting station having a headrail clamp slidable along said drawer, and a hairline sight for positioning said headrail clamp relative to said ruler.

5. The cut down machine of claim 4, said hairline sight including first and second hairlines for selectively adjusting said clamp for cutting window covering products for inside and outside mount installations.

6. The cut down machine of claim 1, including a fourth cutting station above and behind said window blind support surface.

7. The cutdown machine of claim 6, said third window blind cutting station including a drawer beneath said window blind support surface, said drawer including an angular panel having a ruler thereon for measuring the length of a window covering product cut in said third window blind cutting station.

8. The cutdown machine of claim 7, said third window blind cutting station having a headrail clamp slidable along said angular panel and a hairline sight for positioning said headrail clamp relative to said ruler.

9. The cut down machine of claim 8, said hairline sight including first and second hairlines for selectively adjusting said clamp for cutting blinds to be used for inside and outside mount installations.

10. A cut down machine for cutting window blind products of different types, said cutdown machine comprising:
a window blind support surface;
a miniblind cutting station at one end of said window blind support surface positioned for receiving ends of miniblinds supported by said window blind support surface;
a wood and faux wood cutting station having a saw at an opposite end of said window blind support surface from said miniblind cutting station, said wood and faux wood cutting station being positioned for receiving ends of wood and faux wood blinds supported on said window blind support surface; and
a vertical blind headrail cutting station including a headrail clamp movable toward and away from said support surface and having a retracted position beneath said window blind support surface, and a headrail die movable toward and away from said miniblind cutting station.

11. The cut down machine of claim 10, including a cellular blind cutting station above and behind said window blind support surface.

12. The cutdown machine of claim 10, said vertical blind headrail cutting station including a drawer beneath said window blind support surface, said drawer including an angular panel having a ruler thereon for measuring the length of a vertical blind headrail cut in said vertical blind headrail cutting station.

13. The cutdown machine of claim 12, said vertical blind headrail cutting station having a headrail clamp slidable along said angular panel, and a hairline sight for positioning said headrail clamp relative to said ruler.

14. The cut down machine of claim 13, said hairline sight including first and second hairlines for selectively adjusting said headrail clamp for selectively cutting headrails to be used for inside and outside mount installations.

15. A cut down machine for cutting window blind products of different types, including vertical blind headrails and louvers, said cutdown machine comprising:
a window blind support surface;
a plurality of cutting stations for receiving ends of window blinds supported by said window blind support surface; and
a vertical blind headrail cutting station including a headrail clamp movable between a stowed position beneath said window blind support surface and a use position outwardly from an edge of said window blind support surface, and a headrail die near an end of said window blind support surface.

16. The cut down machine of claim 15, said vertical blind headrail cutting station including a drawer having a panel and a ruler on said panel, and said headrail clamp being adjustable along said panel.

17. The cutdown machine of claim 16, said headrail clamp having a hairline sight for positioning said headrail clamp relative to said ruler.

18. The cut down machine of claim 17, said hairline sight including first and second hairlines for selectively adjusting said headrail clamp for selectively cutting headrails to be used for inside and outside mount installations.

19. The cutdown machine of claim 18, including a cutting station for vertical blind louvers above and behind said work surface.

20. The cutdown machine of claim 15, including a cutting station for vertical blind louvers above and behind said work surface.
